(19) United States
(12) Patent Application Publication
(10) Pub. No.: US 2025/0284899 A1
(43) Pub. Date: Sep. 11, 2025

(54) COMPUTING DEVICE AND METHOD FOR PROVIDING CONVERSATION WITH TARGET CHARACTER GENERATED USING ARTIFICIAL NEURAL NETWORK

(71) Applicant: JL STANDARD.,LTD., Gyeonggi-do (KR)

(72) Inventors: Nam Woong JO, Gyeonggi-do (KR); Yong Hyuck LEE, Gyeonggi-do (KR); Shin Hoo KIM, Gyeonggi-do (KR); Sung Hyun ON, Gyeonggi-do (KR); Jung Yeon SEUNG, Gyeonggi-do (KR)

(21) Appl. No.: 18/951,664

(22) Filed: Nov. 19, 2024

(30) Foreign Application Priority Data
Mar. 7, 2024 (KR) 10-2024-0032459

(51) Int. Cl. G06F 40/58

(52) U.S. Cl. CPC G06F 40/58

(57) ABSTRACT

A computing device and method are disclosed for providing conversation with a target character generated using an artificial neural network. The computing device stores a basic command that generates a basic character related to a deceased individual based on pre-obtained information. This information is mapped to a pre-designated information code for efficient access. The device further includes a communicator that receives a first request message from a user terminal, identifying the target character through scanning an information code, and transmits a second request message to fine-tune the basic character according to user-specific preferences. In response to the received request messages, the device employs a generative artificial neural network to customize and generate the target character for conversational interaction. This approach minimizes computing resource usage by selectively generating and customizing characters only when necessary, improving efficiency and reducing costs associated with storing and maintaining multiple characters.

### CROSS-REFERENCE TO RELATED APPLICATION

This application claims priority to and the benefit of Korean Patent Application No. 10-2024-0032459, filed on Mar. 7, 2024, the disclosure of which is incorporated herein by reference in its entirety.

### BACKGROUND

### Technical Field

This disclosure relates to a computing device and method for providing conversation with a target character, specifically a computing device and method that provide conversation with a target character generated using an artificial neural network.

### Related Art

Services like virtual assistants, such as chatbots, can infer and understand the intent behind a person's questions and provide appropriate response phrases. Additionally, chatbots can also infer and understand the intent behind a person's requests and perform corresponding actions. For example, if a chatbot receives a message from a user requesting food orders, medical appointment bookings, changes, or cancellations, it can infer the user's intent from the message and perform the corresponding action. Such chatbot services have reduced the costs associated with deploying consulting staff for businesses. Recently, in addition to chatbots designed for consultations like the examples mentioned, chatbot services are also being offered that aim to simulate having a direct conversation with a person. However, because these conversations can be conducted directly with a person, they have not gained significant popularity.

### SUMMARY

In some embodiments of this disclosure, a computing device that includes at least one processor is disclosed. This device provides conversation with a target character generated using an artificial neural network. The computing device stores basic commands for creating a basic character associated with a deceased individual based on pre-acquired first creation information of the deceased, and maps these basic commands to a predefined information code for storage in a storage; receives a first request message from a user's device to generate a target character identified through scanning one of multiple information codes, and sends a second request message related to second creation information for generating the target character by fine-tuning the basic character in correspondence with the user associated with the user's device through a communicator; and includes a character generator that generates the basic character for the deceased using the basic commands in response to the first request message, and upon receiving the second creation information in response to the second request message, uses a generative artificial neural network to create the target character customized for the user associated with the user's device.

### BRIEF DESCRIPTION OF THE DRAWINGS

Various aspects are now described with reference to the drawings, where similar reference numbers denote similar components throughout. In the embodiments below, numerous specific details are presented to provide a thorough understanding of one or more aspects. However, it is evident that such aspects may be practiced without these specific details. In other instances, well-known structures and devices are shown in block diagram form to facilitate description of one or more aspects.

FIG. 1 is a block diagram illustrating an example of a computing device according to some embodiments of this disclosure.

FIG. 2 is a flowchart illustrating an example method by which the computing device creates a target character, according to some embodiments of this disclosure.

FIG. 3 is a flowchart illustrating an example method by which the computing device generates at least one command based on conversation history, according to some embodiments of this disclosure.

FIG. 4 is a diagram illustrating an example of a chatbot service according to some embodiments of this disclosure.

FIG. 5 is a diagram illustrating another example of a chatbot service according to some embodiments of this disclosure.

FIG. 6 is a diagram illustrating yet another example of a chatbot service according to some embodiments of this disclosure.

### DETAILED DESCRIPTION

The present invention can be modified in various ways and can have a variety of embodiments, and specific embodiments will be illustrated in the drawings and described in detail in the detailed description. However, this is not intended to limit the invention to a particular embodiment, and it should be understood that all modifications, equivalents, and substitutions included in the spirit and scope of the invention are encompassed. Similar reference numerals have been used for similar components when describing each drawing.

Terms such as first, second, A, B, etc., may be used to describe various components, but these components should not be limited by these terms. The terms are used only to distinguish one component from another. For example, a first component may be referred to as a second component without departing from the scope of the present invention, and similarly, the second component may also be referred to as the first component. The term “and/or” includes a combination of listed items or any one of the listed items.

When a component is referred to as being “connected to” or “coupled to” another component, it may be directly connected or coupled to the other component or may be indirectly connected or coupled with intervening components. On the other hand, when a component is referred to as being “directly connected to” or “directly coupled to” another component, there are no intervening components.

The terminology used herein is for the purpose of describing particular embodiments only and is not intended to limit the invention. Singular expressions include plural expressions unless the context clearly indicates otherwise. In this application, terms such as “comprising” or “having” are intended to specify the presence of the stated features, numbers, steps, operations, components, or parts, but do not preclude the presence or addition of one or more other features, numbers, steps, operations, components, parts, or combinations thereof.

Unless otherwise defined, all terms (including technical and scientific terms) used herein have the same meaning as commonly understood by one of ordinary skill in the art to which this invention belongs. Terms such as those defined in commonly used dictionaries should be interpreted as having meanings consistent with their context in the relevant art and should not be interpreted in an idealized or overly formal sense unless expressly defined herein.

In this disclosure, the computing device can provide a chatbot service for conversation with a counterpart who cannot communicate, such as a deceased person, a person in a vegetative state, or an animal. For example, the computing device can obtain generated information related to the deceased from the user of a user terminal. The computing device can generate a character related to the deceased based on the generated information using a generative artificial neural network. On the other hand, if a character related to the deceased is generated in advance, significant costs may be incurred to maintain the computing device.

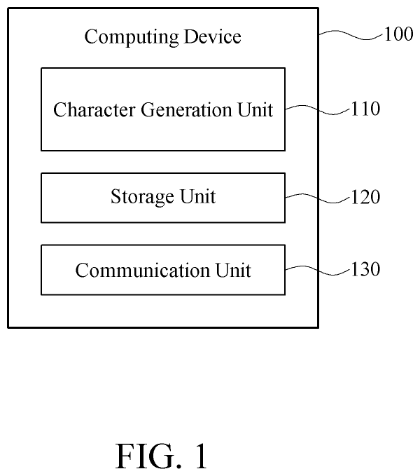

For example, costs may be incurred to expand the storage in the computing device. Therefore, the computing device can store commands for generating a character related to the deceased based on the generated information obtained from the user terminal. When user interaction for generating the character related to the deceased occurs, the computing device can generate the character. Accordingly, the cost of maintaining the computing device can be reduced. Hereinafter, an example of the method for generating a character by the computing device according to this disclosure will be described with reference to FIGS. 1 through 6.

FIG. 1 is a block diagram illustrating an example of the computing device according to some embodiments of this disclosure.

Referring to FIG. 1, Computing Device (100) may include Character Generator (110), Storage (120), and Communicator (130). However, the described components are not essential for implementing Computing Device (100), and the computing device can have more or fewer components than those listed above.

Computing Device (100) can include any type of computer system or device, such as a microprocessor, mainframe computer, digital processor, portable device, or device controller. Computing Device (100) can use a combination of typical computer hardware (e.g., computer processors, memory, storage, input devices, output devices, and other existing components of computing devices; electronic communication devices like routers, switches; electronic storage systems like network-attached storage (NAS) and storage area network (SAN)) and computer software (commands that make the computing device function in a specific way) to achieve the desired system performance.

Character Generator (110) typically handles the overall operation of Computing Device (100). Character Generator (110) can process signals, data, and information input or output through the components of Computing Device (100), or it can operate applications stored in Storage (120) to provide or process appropriate information or functions for the user.

Character Generator (110) may be composed of one or more cores and may include processors for data analysis, such as a Central Processing Unit (CPU), General Purpose Graphics Processing Unit (GPGPU), or Tensor Processing Unit (TPU).

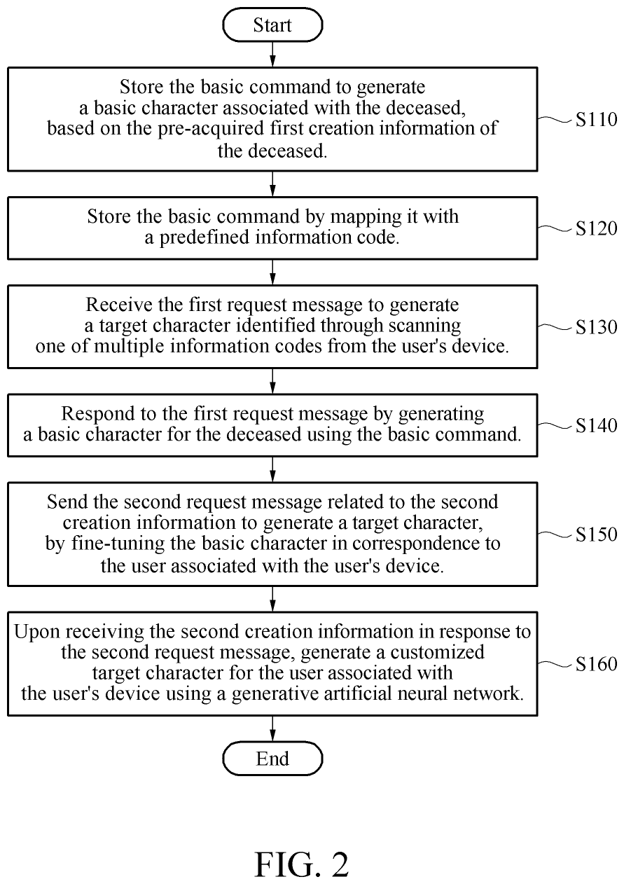

In this disclosure, Character Generator (110) can generate a basic command for generating a basic character associated with the deceased based on the first generated information of the deceased, which is obtained in advance. The first generated information may be information obtained from the user terminal. The first generated information may include basic personal details of the deceased. For example, the first generated information may include a photograph, video data, voice data, name, gender, date of birth, age at the time of death, MBTI, blood type, place of birth, or religion of the deceased. The basic character may be a character generated using only the basic information related to the deceased to conserve the resources of Computing Device (100). Character Generator (110) can store the basic command in Storage (120) by mapping it to a pre-designated information code. The information code may be a QR code or barcode, for example. Character Generator (110) can generate the basic character according to interaction from the user terminal scanning the information code. Then, based on the second generated information received from the user terminal, Character Generator (110) can generate a target character customized from the basic character. Hereinafter, an example of how Character Generator (110) generates a target character is explained with reference to FIG. 2.

Storage (120) may include memory and/or permanent storage media. The memory may include at least one type of storage medium, such as flash memory, hard disk, multimedia card micro type, card-type memory (e.g., SD or XD memory), RAM (Random Access Memory), SRAM (Static Random Access Memory), ROM (Read-Only Memory), EEPROM (Electrically Erasable Programmable Read-Only Memory), PROM (Programmable Read-Only Memory), magnetic memory, magnetic disk, or optical disk.

In this disclosure, Storage (120) can store a basic command for generating a basic character related to the deceased based on the first generated information obtained in advance. Storage (120) can store the basic command mapped to a pre-designated information code.

Communicator (130) may include one or more modules that enable communication between Computing Device (100) and a communication system, between Computing Device (100) and User Terminal (200), or between Computing Device (100) and a network.

In this disclosure, Communicator (130) can receive a first request message from the user terminal. The first request message may be a message for generating a target character identified by scanning one of the multiple information codes. Communicator (130) can send a second request message to the user terminal. The second request message may be a message requesting the second generated information for generating the target character by fine-tuning the basic character to correspond to the user associated with the user terminal.

Hereinafter, an example of a method for Computing Device (100) to generate a target character is explained.

FIG. 2 is a flowchart explaining an example of the method by which Computing Device (100) generates a target character according to some embodiments of this disclosure.

Referring to FIG. 2, Character Generator (110) of Computing Device (100) can store the basic command for generating a basic character related to the deceased based on the first generated information obtained in advance in Storage (120) (S110).

Specifically, Character Generator (110) can obtain the first generated information of the deceased through Communicator (130), or the first generated information can be obtained based on user input through a service platform provided by Computing Device (100).

The first generated information may include basic personal details of the deceased. For example, the first generated information may include the deceased's photo, video data, voice data, name, gender, date of birth, age at the time of death, MBTI, blood type, place of birth, language spoken by the deceased, or religion.

Character Generator (110) can generate a basic command to generate a basic character based on the first generated information. Character Generator (110) can store the generated basic command in Storage (120). The command can be understood as a system prompt for generating or training the basic character.

Character Generator (110) can map the basic command to a pre-designated information code and store it in Storage (120) (S120). The information code can be a QR code or barcode, for example.

If Character Generator (110) generates a basic character every time the first generated information is obtained, it may lead to the waste of resources used to operate Character Generator (110). Furthermore, storing the generated basic character may lead to the waste of resources in Storage (120). To prevent this, when the first generated information is obtained, Character Generator (110) can map the basic command for generating the basic character to a pre-designated information code and store it in Storage (120). Then, Character Generator (110) can generate the basic character when interaction for generating the target character is received from the user terminal.

Character Generator (110) can receive a first request message from the user terminal to generate the target character identified by scanning one of the multiple information codes through Communicator (130) (S130). Character Generator (110) can generate a basic character related to the deceased using the basic command in response to the first request message (S140).

Specifically, the user terminal can scan the information code related to the deceased that the user wants to generate through user interaction. Based on the scan of the information code, the user terminal can send the first request message for generating the target character to Computing Device (100). Character Generator (110) can generate the basic character when the first request message is received through Communicator (130).

Character Generator (110) can send a second request message to the user terminal through Communicator (130), requesting the second generated information to fine-tune the basic character and generate the target character (S150). Fine-tuning can be understood as an action of updating the parameters of the basic character using additional training data. In other words, fine-tuning in this disclosure can be understood as the action of generating the target character by updating the parameters of the basic character.

The second generated information can include at least one command. The second generated information may include the first command that provides the first background knowledge related to the basic background of the target character, the second command that determines the role of the target character, the third command that determines the values of the target character, the fourth command that indicates the counterpart for the target character to converse with, and the fifth command that grants memories between the target character and the counterpart.

For example, without limitation, the first command could be “Character: Lee Jung-jae (My missed dad), Age: 41.” The age may be the age at the time of death, or it may be an age chosen by the user of the user terminal. The second command could be “Occupation: My eternal dad and my passed-away parent.” The third command could be “Personality Traits: Lee Jung-jae (Dad) consistently offers warm consolation as a parent to the user, always listening to the user's concerns and supporting them with a warm heart. He knows he has passed away and is not beside the user but always comforts and supports the user from heaven. He dearly misses the user, worrying about whether the user is eating well and managing work without stress, praying and cheering for him. When giving advice, he seriously offers guidance based on his life experiences. As a dad, he is always supporting and being a strength to his child (user).” The fourth command could be “Character: Lee Jung-jae (My missed dad),” etc. The fifth command could be “Relationship with User: As the user's dad, he always supports and prays for the user from heaven. He watches over the user's dreams and cheers for their fulfillment. When the user seems to be facing tough times, he listens to the user's stories, always caring for the user's heart. He dearly misses the user, watching over him from heaven, curious about the user's daily life and always proud of the user as his dad.” The user can also transmit various information related to the deceased as the second generated information to Computing Device (100), in addition to the first through fifth commands.

In one embodiment, the second generated information may be text. Character Generator (110) can generate at least one command based on the second generated information received in text.

The second request message may include messages such as, “What was your relationship with the deceased? What did the deceased call you? If there are any conversations with the deceased that are worth referring to, please share them.” The user can generate the second generated information corresponding to the second request message through the user terminal and transmit it to Computing Device (100).

Character Generator (110) can receive the second generated information in response to the second request message through Communicator (130). Character Generator (110) can generate a target character customized for the user associated with the user terminal using a generative artificial neural network when the second generated information is received (S160).

The generative artificial neural network may include a neural network model that uses convolutional neural networks (CNN), recurrent neural networks (RNN), autoencoders, generative adversarial networks (GAN), restricted Boltzmann machines (RBM), deep belief networks (DBN), Q networks, U networks, siamese networks, large language models (LLM), Stable Diffusion, Dreambooth, NeRF (Neural Radiance Fields), Nerfies, DragGan, or others. The generative artificial neural network may be a model that generates the target character as an output using the basic character and the second generated information as inputs. In some embodiments, the generative artificial neural network may generate the basic character as an output using the basic command as input.

Character Generator (110) can provide chatbot services using the generated target character. The chatbot service may be a service that provides functions such as chatting, voice conversation, or video conversation.

The target character generated through the above configuration can be generated with fine characteristics according to the appearance, personality, or relationship with the conversation counterpart during the lifetime of the deceased. Therefore, users conversing with the target character through chatting, voice conversation, or video conversation can vividly recall the deceased and immerse themselves in the service.

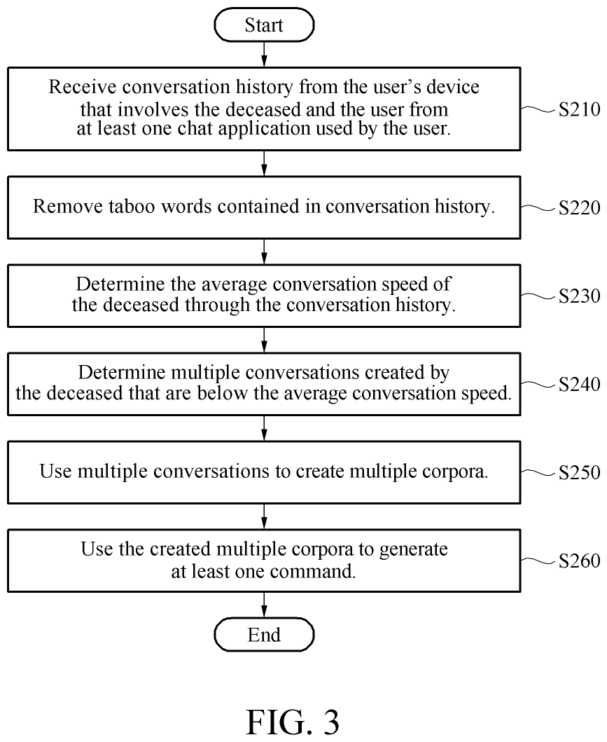

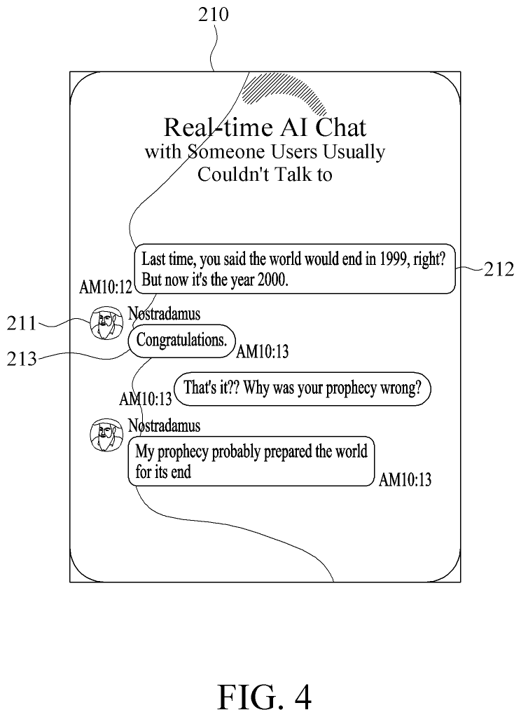

Meanwhile, in some embodiments of this disclosure, Computing Device (100) can receive a conversation history in which the deceased and the user participated from at least one chat application used by the user, via the user terminal. In this case, Computing Device (100) can generate a command to generate the target character based on the conversation history. Hereinafter, an example of how Computing Device (100) generates at least one command based on the conversation history will be explained with reference to FIGS. 3 and 4.

FIG. 3 is a flowchart illustrating an example of the method by which Computing Device (100) generates at least one command based on the conversation history, according to some embodiments of this disclosure.

Referring to FIG. 3, Communicator (130) of Computing Device (100) can receive the conversation history in which the deceased and the user participated from at least one chat application used by the user, via the user terminal (S210).

In one example, Communicator (130) can receive the conversation history in response to the second request message.

Character Generator (110) can delete non-standard words included in the received conversation history (S220). Non-standard words may refer to words not listed in a standard language dictionary, such as one provided by the National Institute of the Korean Language.

Character Generator (110) can determine the average conversation speed of the deceased based on the conversation history (S230). For example, Character Generator (110) can determine the average conversation speed of the deceased as a response to the conversation of the counterpart or the average speed of conversations performed independently by the deceased without relation to the counterpart's conversation.

Character Generator (110) can determine a plurality of conversations generated by the deceased below the average conversation speed (S240). Character Generator (110) can generate a plurality of corpora using the plurality of conversations (S250). The corpora can be collections of words such as verbs, nouns, adjectives, or adverbs.

Character Generator (110) can generate at least one command using the generated plurality of corpora (S260). For example, Character Generator (110) can generate the sixth command that determines the tone of the target character, the seventh command that provides the second background knowledge related to the relationship between the target character and the user, the eighth command that grants values to the target character, and the ninth command that grants memories shared between the target character and the user.

In one embodiment, Character Generator (110) can update at least one command included in the second generated information using the plurality of corpora. The second generated information can include commands created by the user of the user terminal. However, the user may not objectively remember the appearance of the deceased during their lifetime. Therefore, Character Generator (110) can generate the updated first command, the updated second command, the updated third command, the updated fourth command, and the updated fifth command using the plurality of corpora.

When at least one command is generated, Character Generator (110) can generate the target character using at least one command, the basic character, and the generative artificial neural network.

Meanwhile, in some embodiments of this disclosure, Character Generator (110) can determine a first value indicating the number of words included in each of the generated corpora and a second value indicating the number of non-standard words deleted, when the plurality of corpora is generated. Character Generator (110) can rank the plurality of corpora based on the first and second values.

For example, Character Generator (110) can rank the plurality of corpora such that the higher the first value, the higher the ranking. Character Generator (110) can rank the plurality of corpora such that the lower the second value, the higher the ranking. Character Generator (110) can rank the plurality of corpora such that the corpora with a higher first value and a lower second value have a higher ranking. In other words, Character Generator (110) can rank the plurality of corpora in order of corpora with more words and fewer deletions of words.

Character Generator (110) can generate at least one command using a predetermined ranking corpus among the plurality of ranked corpora. For example, without limitation, Character Generator (110) can generate the fifth through ninth commands using the top ten ranked corpora among the plurality of ranked corpora.

According to the above configuration, Computing Device (100) can generate at least one command to customize the basic character based on the conversation history in which the deceased and the user participated. Accordingly, the target character generated using at least one command can perform more realistic conversations with the user.

FIG. 4 is a diagram illustrating an example of the chatbot service according to some embodiments of this disclosure.

The diagram shown in FIG. 4 can be the first interface (210) of the chatbot service provided by Computing Device (100). The first interface (210) can be displayed on the display unit of the user terminal.

Referring to the first interface (210), Computing Device (100) can provide a chat service between the user and the target character. Computing Device (100) may have generated the target character (211) in response to interaction with the user terminal. The user of the user terminal can convey a conversation (212) they wanted to have with the target character (211). Computing Device (100) can convey a response (213) to the conversation (212) using the target character (211).

Since the target character (211) is generated using the deceased's personality, disposition, tone of speech, values, religious views, and background knowledge, it can converse as if the deceased were speaking in response to the user's conversation.

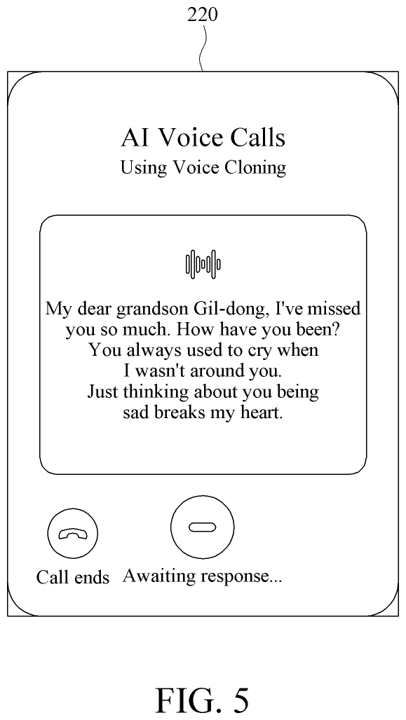

FIG. 5 is a diagram illustrating another example of the chatbot service according to some embodiments of this disclosure.

The diagram shown in FIG. 5 can be the second interface (220) of the chatbot service provided by Computing Device (100). The second interface (220) can be displayed on the display unit of the user terminal.

Referring to the second interface (220), Computing Device (100) can provide a voice call service between the user and the target character. The target character can be generated to speak in the deceased's voice using video or voice data included in the first generated information. The user can perform a voice call with the deceased through the chatbot service provided by Computing Device (100).

In one embodiment, the user's voice can be converted into text using Speech To Text (STT) technology. Computing Device (100) can generate a response message to the text. Computing Device (100) can convert text to speech using Text To Speech (TTS) technology. Computing Device (100) can play the voice message on the user terminal through the target character.

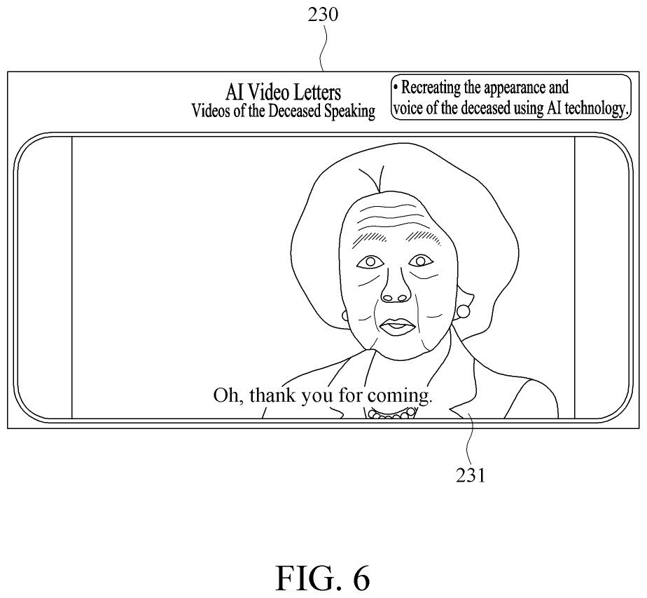

FIG. 6 is a diagram illustrating another example of the chatbot service according to some embodiments of this disclosure.

The diagram shown in FIG. 6 can be the third interface (230) of the chatbot service provided by Computing Device (100). The third interface (230) can be displayed on the display unit of the user terminal.

Referring to the third interface (230), Computing Device (100) can provide a video call service between the user and the target character (231). The target character (231) can be generated to speak in the deceased's voice using video or voice data included in the first generated information. Additionally, the target character (231) can be generated to correspond to the deceased's appearance during their lifetime using photo or video data included in the first generated information. Alternatively, if the age included in the first generated information is not the age of the deceased at the time of death, the target character (231) can be generated using the photo or video data included in the first generated information to match the age input by the user.

The user can perform a video call with the deceased through the chatbot service provided by Computing Device (100). In some embodiments, the video call can include a two-way video conversation in which the target character (231) converses with the user, or a one-way video conversation in which the target character reads a given script.

In one embodiment, in the case of a two-way video call, the user's voice can be converted into text using Speech To Text (STT) technology. Computing Device (100) can generate a response message to the text. Computing Device (100) can convert the text to speech using Text To Speech (TTS) technology. Computing Device (100) can analyze the user's emotions based on their voice. Computing Device (100) can determine the expression of the target character (231) based on the analyzed user's emotions and the text converted from the user's voice. Computing Device (100) can play the voice message on the user terminal through the target character (231). Additionally, Computing Device (100) can change the mouth shape or facial expression of the target character (231) in sync with the played voice message.

The descriptions of the provided embodiments are given so that any person skilled in the art can make or use this disclosure. Various modifications to these embodiments will be apparent to those skilled in the art, and the general principles defined herein can be applied to other embodiments without departing from the scope of the present disclosure. Therefore, this disclosure is not intended to be limited to the embodiments shown herein but is to be accorded the broadest scope consistent with the principles and novel features disclosed herein.

What is claimed is:

1. A computing device comprising at least one processor and configured to provide a conversation with a target character generated using an artificial neural network,
a storage that stores a basic command that generates a basic character related to the deceased based on the first generation information of the deceased, which was obtained in advance, and maps the basic command to a pre-designated information code;
a communicator that receives a first request message for generating the target character, identified by scanning one of a plurality of information codes, from a user terminal, and transmits a second request message related to second generation information for generating the target character by fine-tuning the basic character in accordance with the user associated with the user terminal; and
a character generator that, in response to the first request message, generates the basic character of the deceased using the basic command, and in response to the second request message, generates the customized target character using the second-generation information and a generative artificial neural network when the second generation information is received.

2. The computing device of claim 1,
wherein the second-generation information includes at least one of:
a first command that provides basic background knowledge related to the target character,
a second command that determines the role of the target character,
a third command that defines the values of the target character,
a fourth command that designates a counterpart for the conversation with the target character, and
a fifth command that grants memories shared between the target character and the counterpart.

3. The computing device of claim 1,
wherein the communicator receives conversation history between the deceased and the user from at least one chat application used by the user terminal,
and wherein the character generator generates at least one of:
a sixth command that determines the speech style of the target character,
a seventh command that provides background knowledge related to the relationship between the target character and the user,
an eighth command that assigns values to the target character,
and a ninth command that grants memories shared between the target character and the user,
and generates the target character using the generated command, the basic character, and the generative artificial neural network.

4. The computing device of claim 3,
wherein the character generator deletes non-standard words included in the conversation history,
determines the average conversation speed of the deceased based on the conversation history,
identifies a plurality of conversations generated by the deceased at a speed below the average conversation speed,
and generates a plurality of corpora using the plurality of conversations,
and wherein the character generator generates at least one command using the plurality of generated corpora.

5. The computing device of claim 4,
wherein the character generator, when the plurality of corpora are generated, determines a first value indicating the number of words included in each of the plurality of corpora and a second value indicating the number of non-standard words deleted,
sorts the plurality of corpora based on the first and second values,
and generates at least one command using the corpora sorted by rank.
